(19) United States
(12) Patent Application Publication
(10) Pub. No.: US 2008/0133924 A1
(43) Pub. Date: Jun. 5, 2008

(54) Method for Checking Electronic Authorizaiton Inspection Information, Tester and Computer Program

(75) Inventors: Marek Alexander Gadau, Dresden (DE); Klaus Roder, Bannewitz (DE)

Correspondence Address: LERNER GREENBERG STEMER LLP, P O BOX 2480, HOLLYWOOD, FL, 33022-2480, US

(73) Assignee: Siemens Aktiengesellschaft

(21) Appl. No.: 11/661,005

(22) PCT Filed: Aug. 22, 2005
(86) PCT No.: PCT/EP05/09062

§ 371 Date: Jul. 16, 2007

(30) Foreign Application Priority Data
Aug. 23, 2004 (DE) 10 2004 041 674.5

(51) Int. Cl. H04L 9/32

(52) U.S. Cl. 713/176

(57) ABSTRACT

A method for checking electronic authorization inspection information, in which an electronic authorization inspection information item comprises text and/or graphics information describing usable services, a reference to a user identification document and a digital signature which is calculated from the text and/or graphics information and the reference to the user identification document using a private key for an asymmetric encryption method. The authorization inspection information item is stored in a data processing system belonging to a trustworthy entity and in an electronic appliance belonging to a user. Nominal presets for the check are ascertained by retrieving the authorization inspection information item stored in the data processing system or by detecting the digital signature stored in the appliance, reading it using a public key associated with the private key and breaking it down into text and/or graphics information and a reference to the user identification document. The text and/or graphics information describing usable services and the reference to the user identification document for the authorization inspection information item stored in the electronic appliance are compared with a respective nominal preset for a match, presence of the user identification document is ascertained.

Method for checking electronic authorization inspection information, tester and computer program

Methods for checking authorization inspection information are used primarily to establish beyond doubt whether a user or a person has valid authorization to use a service, for example a journey by local public transport or a visit to an event. In particular, it is necessary to ensure that authorization inspection information has not been altered or duplicated without authorization.

Paper tickets are made secure against forgery essentially by using special paper. This means that the unique nature of a paper ticket is based on a medium whose procurement or forgery is usually possible at the outside with a very high level of complexity.

In previously known approaches to checking electronic authorization inspection information, an information item is sent to a user's mobile telephone as evidence of the presence of authorization. This information item is used for visual inspection or for reading and inspection by means of a mobile tester which has a bar code reader, for example. If required, it is possible to feed back to a background system for online inspection. Alteration of authorization stored in the mobile telephone or passing-on of copies of an authorization to other mobile telephones is not evident with visual inspection and is not evident beyond doubt with online inspection. In addition, visual inspection features need to have their validity checked by an inspector, which gives rise to further sources of error.

DE 199 33 731 A1 discloses a method for form-independent and verifiable concession of use authorizations for provided services, for example transport, hotel and travel services or vehicle rental. This method involves a key code being stored in centralized fashion and a party interested in use being assigned an individual code and being notified of it for retrieval. The key code, a service name and the individual code are used to create an encrypted authorization code, and the party interested in use is notified of this for retrieval, for example on a nonelectronic, self-created document. When the key code and the individual code are available, the service name can be restored from the authorization code. However, use of the same key code for encryption and decryption requires special precautions for continual secrecy of the key code, especially in the case of mobile testers.

WO 03/73387 describes a method for checking the authenticity of nonelectronic documents. A nonelectronic document is provided with a document identifier, text and/or graphics useful information, an at least implicit information item about the issuer of the document and a digital signature, which is an encrypted first test code calculated by means of a selected test function from the document identifier and the text and/or graphics useful information. The document identifier, the text and/or graphics useful information and the signature are first of all scanned. A second test code is calculated from the scanned document identifier and the scanned text and/or graphics useful information using the selected test function. The scanned signature is decrypted in order to ascertain the first test code using the at least implicit information about the issuer of the document. The first and second test codes are compared for a match.

DE 103 05 371 A1 discloses a method for conceding use authorizations by checking form-independent, nonelectronic documents. A form-independent, nonelectronic document is provided with text and/or graphics information, a reference to a user identification document and a digital signature. The digital signature is calculated from the text and/or graphics information in restorably compressed form, and the reference to the user identification document using a private key for an asymmetric encryption method. The digital signature is scanned, is read using a public key associated with the private key and is broken down into compressed text and/or graphics information and a reference to the user identification document. The compressed text and/or graphics information is decompressed. The decompressed text and/or graphics information and the reference to the user identification document are compared with a respective nominal preset for a match. In the event of a match, a use authorization signal is generated.

The present invention is based on the object of providing a method for checking electronic authorization inspection information which allows safe recognition of manipulative alterations to electronic authorization inspection information and of unauthorized copies.

The invention achieves this object by means of a method having the features specified in claim 1, a test device having the features specified in claim 7 and a computer program having the features specified in claim 8. Advantageous developments of the present invention are specified in the dependent claims.

A fundamental aspect of the present invention is that an electronic authorization inspection information item is provided with text and/or graphics information describing usable services, a reference to a user identification document and a digital signature. The digital signature is calculated from the text and/or graphics information and the reference to the user identification document using a private key for an asymmetric encryption method. The authorization inspection information is stored in a data processing system belonging to a trustworthy entity and in an electronic appliance belonging to a user. Nominal presets for the check are ascertained by retrieving the authorization inspection information item stored in the data processing system or detecting the digital signature stored in the appliance. If the digital signature stored in the appliance is detected then it is read using a public key associated with the private key and is broken down into text and/or graphics information and a reference to the user identification document. The text and/or graphics information describing usable services and the reference to the user identification document for the authorization inspection information item stored in the electronic appliance are then compared with a respective nominal preset for a match. Finally, presence of the user identification document is ascertained. Following conclusion of the check, an offer of use can be made available to an authorized user.

The way in which the invention achieves the object is based on the use of a forgery-proof or difficult-to-forge inspection medium, namely the user identification document. In this context, this may be a medium which the user already has and which is accepted by an operator of a checking system, such as a credit card, EC card, personal identification or the like, or a medium issued by the operator. The inspection medium can preferably be clearly identified by type, number and expiry date.

In order to use services, a user registers with the operator or service provider, for example by indicating the type, number and expiry date of the inspection medium which is to be used. The type and number of the inspection medium are used as data elements of the electronic authorization inspection information item, for example. Appropriately, an authorization inspection information item is valid if the user can produce the right inspection medium. By way of example, this ensures that authorization to use a service can be recognized as legitimate only for one user at a time.

By storing the authorization inspection information item in a data processing system belonging to a trustworthy entity, which can be considered safe a priori and which allows legally binding storage of an original of the authorization inspection information item for evidential purposes, and in an electronic appliance belonging to a user, it is possible to inspect an electronic authorization inspection information item both offline—that is to say without a connection to the data processing system—and online. By authorizing a digital signature using the text and/or graphics information and the reference to the user identification document, it is possible to establish for an offline check on the electronic authorization inspection information item whether this information item has been altered from an original state.

The present invention is explained in more detail below using an exemplary embodiment with reference to the drawing, in which:

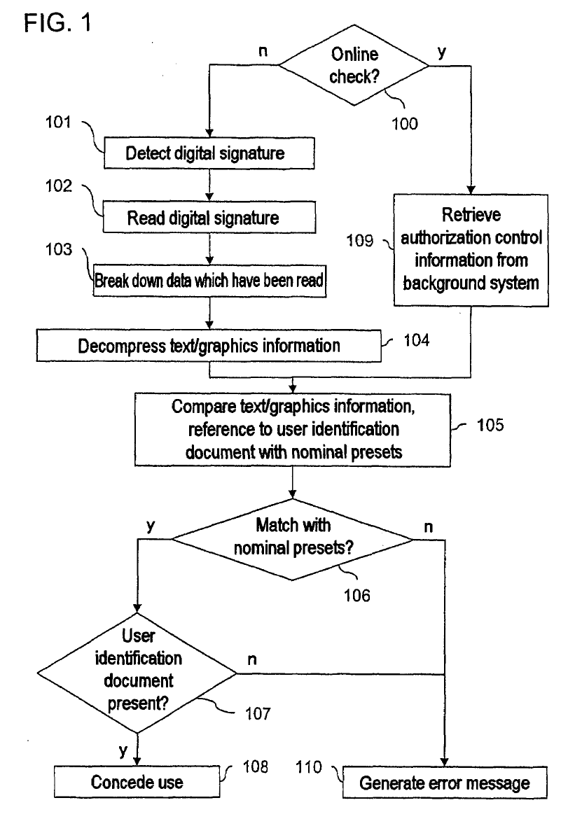

FIG. 1 shows a flowchart for a method for checking electronic authorization inspection information,

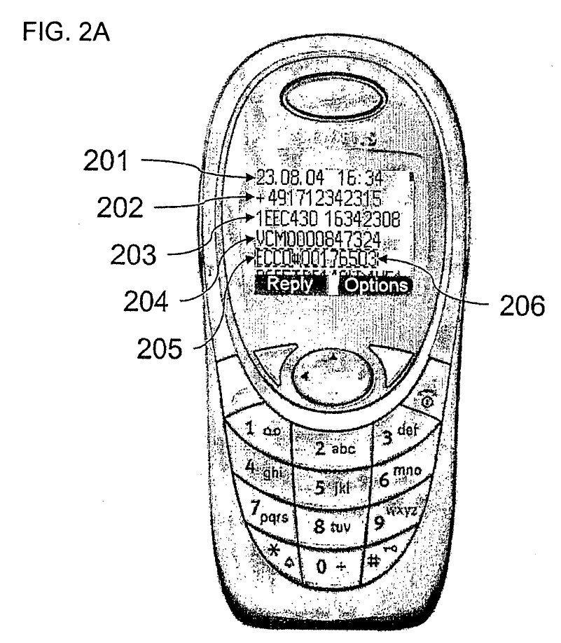

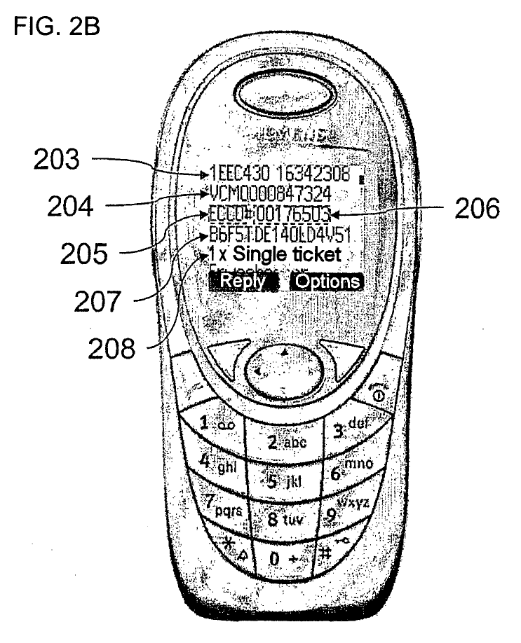

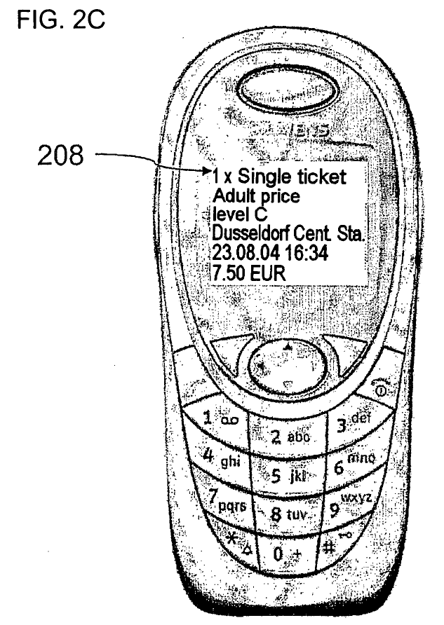

FIGS. 2a-c show a user interface on an exemplary mobile communication terminal, showing electronic authorization inspection information which is to be tested.

The method illustrated in FIG. 1 by means of a flowchart involves conceding use authorizations by checking electronic authorization inspection information. An authorization inspection information item which is subjected to the check and whose display on a user interface on a mobile communication terminal is shown in FIGS. 2a-c has text and/or graphics information 208 describing usable services, a reference 204 to a user identification document (inspection medium) and a digital signature 207. The digital signature 207 is calculated from the text and/or graphics information 208 in restorably compressed form and the reference 204 to the user identification document using a private key for an asymmetric encryption method. The authorization inspection information item is stored in a data processing system belonging to a trustworthy entity (a priori safe background system) and in the mobile communication terminal belonging to a user.

Besides the text and/or graphics information 208 describing usable services, the reference 204 to the user identification document and the signature 207, the authorization inspection information item has statements regarding
date and time 201 of dispatch of the authorization inspection information item to the mobile communication terminal,
telephone number 202 of the sender of the authorization inspection information item,
provider code 203 for usable services,
code 205 for visual inspection, and
order identifier 206.

The date and time 201 of dispatch allows manipulation to be recognized, particularly by passing-on in the case of a visual inspection, if the date and time are after the start of validity of an authorization. The provider code 203 is a single-line representation showing a service description for a service used. Manipulation of the provider code 203 or of the reference 204 to the user identification document, for example by editing, can be recognized during the visual inspection using the visual inspection code 205. The visual inspection code 205 is based on a method, which changes over time, which is used to calculate code words.

The reference 204 to the user identification document comprises an encoded representation of the inspection media type (personal identification, driver's license, credit card or the like) and the number of the respective inspection medium. Passing-on of the authorization inspection information item can be recognized during an actual visual inspection, since only one authorized user is able to produce the designated inspection medium.

Nominal presets for a check on the authorization inspection information item can be ascertained both in online mode—that is to say when there is a connection between a mobile tester and the background system—and in offline mode. To this end, step 100 tests whether the check on the authorization inspection information item is to be performed online or offline. In the case of an online check, the authorization inspection information item stored in the background system is retrieved in order to ascertain the nominal presets (step 109). By contrast, in an offline check, the digital signature 207 stored in the mobile communication terminal is first of all detected (step 101). The signature 207 is then read using a public key associated with the private key (step 102) and is broken down into text and/or graphics information and a reference to the user identification document (step 103). The compressed text and/or graphics information is then decompressed (step 104).

The text and/or graphics information 208 and the reference 204 to the user identification document are then compared with a respective nominal preset (step 105) and are checked for a match (106). If there is a match, presence of the user identification document is ascertained (step 107), and in the positive case a concession is given for use (step 108). If there is no match with the nominal presets, an error message is generated (step 110).

The method described above is implemented by a computer program which is installed on a computer-aided mobile tester (not shown in more detail), for example. The computer program can be loaded into a main memory of the mobile tester and has at least one code section which, when executed, carries out the steps of the method described above when the computer program is running in the mobile tester. In addition, the mobile tester may be equipped with a scanner and with a mobile telephony terminal functionality. By way of example, a mobile telephony terminal functionality simplifies need-oriented reloading of public keys onto the mobile tester or retrieval of authorization inspection information stored in the background system for the online check. By way of example, it makes sense to reload public keys when authorization inspection information is created using private keys from alternative agencies, providers or organizers.

Security features, such as the inspection medium, a digital signature and a background system which is safe a priori, can be applied to all-inclusive and discrete authorizations equally. An all-inclusive authorization allows use of services with registration and retrospective billing. Discrete authorization allows use of one defined service following prior purchase.

When checking all-inclusive authorization, registration of the type and number of the inspection medium establishes use of a used service and there is an immediate or later check in the background system to determine whether there was appropriate authorization at the time of inspection.

When checking discrete authorizations, an inspection appliance without a connection to the background system can be used to establish whether an electronic authorization inspection information item in unforged form has been presented. By comparing authorization data with data from the inspection medium, an inspection appliance can be used to establish whether an authorized user has presented an electronic authorization inspection information item.

The use of the present invention is not limited to the exemplary embodiment described here.

1-7. (canceled)

8-9. (canceled)

10. A method for checking electronic authorization inspection information, which comprises the following method steps:
providing an electronic authorization inspection information item including text and/or graphics information describing usable services, a reference to a user identification document, and a digital signature calculated from the text and/or graphics information and the reference to the user identification document using a private key for an asymmetric encryption method;
storing the authorization inspection information item in a data processing system belonging to a trustworthy entity and in an electronic appliance associated with a user;
ascertaining nominal presets by retrieving the authorization inspection information item stored in the data processing system or by detecting the digital signature stored in the appliance, reading the authorization inspection information item using a public key associated with the private key, and breaking the authorization inspection information item down into text and/or graphics information and a reference to the user identification document;
comparing the text and/or graphics information describing usable services and the reference to the user identification document for the authorization inspection information item stored in the electronic appliance with a respective nominal preset for a match; and
ascertaining a presence of the user identification document.

11. The method according to claim 10, wherein the electronic appliance associated with the user is a mobile communication terminal.

12. The method according to claim 10, wherein the user identification document comprises statements regarding document type, document number, and expiry date.

13. The method according to claim 10, which comprises calculating the digital signature from the text and/or graphics information in restorably compressed form and the reference to the user identification document, breaking down the digital signature into compressed text and/or graphics information and a reference to the user identification document, and decompressing the compressed text and/or graphics information.

14. The method according to claim 10, which comprises optically scanning the digital signature.

15. The method according to claim 10, which comprises extracting a service name for an offer of use from the text and/or graphics information and comparing the service name with a nominal preset set on a tester for a match.

16. A test device for checking electronic authorization inspection information, comprising:
means for prompting retrieval of an authorization inspection information item stored in a data processing system belonging to a trustworthy entity or for prompting scanning of a digital signature for an electronic authorization inspection information item which includes text and/or graphics information, a reference to a user identification document, and the digital signature, wherein the digital signature is calculated from the text and/or graphics information and the reference to the user identification document using a private key for an asymmetric encryption method;
means for reading the scanned digital signature using a public key associated with the private key and for breaking the digital signature down into text and/or graphics information and a reference to the user identification document; and
means for comparing the text and/or graphics information and the reference to the user identification document for a match with a respective nominal preset.

17. A computer program for checking electronic authorization inspection information for loading into a main memory of a computation device, the computer program having at least one code section which, when executed on the computation device, performs the following steps:
prompting for a retrieval of an authorization inspection information item stored in a data processing system belonging to a trustworthy entity or for a scanning of a digital signature for an electronic authorization inspection information item which has text and/or graphics information, a reference to a user identification document, and the digital signature, wherein the digital signature is calculated from the text and/or graphics information and the reference to the user identification document using a private key for an asymmetric encryption method;
in a case of scanning the digital signature, prompting the scanned digital signature to be read using a public key associated with the private key and to be broken down into text and/or graphics information and a reference to the user identification document; and
comparing the text and/or graphics information and the reference to the user identification document with a respective nominal preset for a match.
